(19) United States
(12) Patent Application Publication
(10) Pub. No.: US 2025/0253964 A1
(43) Pub. Date: Aug. 7, 2025

(54) Wired Communication System and Method for Determining a Transmission Signal Strength of a Number of Transceivers

(71) Applicant: Bayerische Motoren Werke Aktiengesellschaft, Muenchen (DE)

(72) Inventor: Helmut Kellermann, Oberschleissheim (DE)

(21) Appl. No.: 18/854,457

(22) PCT Filed: Jan. 24, 2023
(86) PCT No.: PCT/EP2023/051719

§ 371 Date: Oct. 4, 2024

(30) Foreign Application Priority Data
May 5, 2022 (DE) 10 2022 111 224.1

(51) Int. Cl. H04B 17/318; H04L 5/00; H04L 12/40

(52) U.S. Cl. CPC H04B 17/328; H04L 5/0098; H04L 2012/40273

(57) ABSTRACT

A wired communication system includes a plurality of transceivers that are interconnected via a wired communication bus. A transmit signal strength of the respective transceivers is individually set such that, on the respective transceivers, a ratio between a maximum received signal strength and a minimum received signal strength of transmit signals of other transceivers is reduced compared to other transmit signal strength configurations of the respective transceivers.

The present application is the U.S. national phase of PCT Application PCT/EP2023/051719 filed on Jan. 24, 2023, which claims priority of German patent application No. 10 2022 111 224.1 filed on May 5, 2022, the entire contents of which are incorporated herein by reference.

### TECHNICAL FIELD

The disclosure relates to a wired communication system and to a method for determining a transmit signal strength of a plurality of transceivers.

### BACKGROUND

Modern vehicles contain a multiplicity of separate components, such as e.g. separate control devices or sensors. Such control devices are interconnected, for example, via a vehicle bus. A multiplicity of control devices and sensors can be interconnected via the same vehicle bus, wherein the control devices and sensors can potentially communicate with every other device connected to the bus. This can result in substantial differences in terms of the received signal strengths detected on the respective devices, e.g. due to line loss, depending on which device is transmitting, thus hindering the signal processing at the receiving end.

A need exists for an improved concept for communication via a wired bus, and, in particular, via a wired vehicle bus.

### SUMMARY

This above-state need, as well as others, are addressed by at least some embodiment disclosed and claimed herein.

This disclosure is based on the realization that the signal processing at the receiving end can be improved by reducing the difference between a maximum and a minimum received signal strength which is detected on a receiver. The different received signal strengths can thereby be adjusted so that the dynamic range of the respective receiver can be set to a smaller difference between the minimum received signal strength and the maximum received signal strength. Since bus systems are usually static systems, it is possible here to preset the transmit signal strength of the individual transceivers such that, across the transceivers connected to the bus, the ratio between the maximum received signal strength and the minimum received signal strength is reduced or minimized compared with other transmit signal strength configurations.

A first subject-matter of the present disclosure relates to a wired communication system. The wired communication system comprises a plurality of transceivers which are interconnected via a wired communication bus. A transmit signal strength of the respective transceivers is individually set such that, on the respective transceivers, a ratio between a maximum received signal strength and minimum received signal strength of transmit signals of other transceivers is reduced compared to other transmit signal strength configurations. As mentioned, the dynamic range of the receiver can be more effectively utilized as a result.

The proposed concept can also be applied to OFDMA (Orthogonal Frequency Division Multiple Access)-based bus systems on which subbands of a plurality of orthogonal subbands are used in parallel with one another so that a plurality of transceivers can transmit simultaneously. The plurality of transceivers can thus be designed to communicate with one another over a plurality of frequency bands so that, according to the number of frequency bands that are used, a corresponding number of transceivers can transmit simultaneously.

In the proposed concept, not only can the transmit signal strengths be set, but the received gain of the transceivers can also be adjusted accordingly. In particular, the received gain of the transceivers can be set on the respective transceiver based on a sum of received signal strengths. This replicates the scenario in which a plurality of transceivers can transmit, e.g. using an OFDMA method, without overloading the transceivers in receive mode.

As described above, the plurality of transceivers can thus be designed to communicate with one another over a plurality of frequency bands so that, according to the number of frequency bands that are used, a corresponding number of transceivers can transmit simultaneously. The sum of received signal strengths can be formed accordingly based on the number of frequency bands that are used. The “loudest” other transceivers, for example, can be taken into account, according to the number of frequency bands that are used.

The transmit signal strengths of the transceivers can be individually set by means of the proposed concept so that the ratio between the respective minimum and maximum of the received signal strength is reduced. The transmit signal strengths can be set accordingly so that the plurality of transceivers comprise at least a first and a second transceiver, wherein a transmit signal strength of the first transceiver differs from a transmit signal strength of the second transceiver.

The proposed concept is focused specifically on setting the transmit signal strengths of all transceivers as equal. The signal strength of the respective transceivers can thus be individually set such that, on the respective transceivers, the ratio between the maximum received signal strength and the minimum received signal strength of transmit signals of other transceivers is reduced, in particular compared to a transmit signal strength configuration in which each transceiver uses the same transmit signal strength. The advantageous effect is thereby achieved.

Wired communication systems, and in particular bus communication systems of vehicles, contain transceivers which only receive data. These transceivers can be ignored, for the minima and maxima. Transmit signals, for example of transceivers for which it is provided that said transceivers communicate in transmit mode via the communication bus, can be taken into account (exclusively) in determining the received signal strengths.

The transmit signal strengths and/or the respective received gain of the transceivers, for example, can be set using the following method.

A second subject-matter of the present disclosure relates to a method for determining a transmit signal strength of a plurality of transceivers which are interconnected via a wired communication bus. The method comprises determining, for each transceiver, a maximum received signal strength and a minimum received signal strength of transmit signals of other transceivers based on a predefined transmit signal strength configuration. The method further comprises adapting the individual transmit signal strengths of the transceivers such that a ratio between the maximum received signal strength and the minimum received signal strength of transmit signals of other transceivers is reduced compared to other transmit signal strength configurations. As mentioned, the dynamic range of the receiver can be more effectively utilized as a result.

Furthermore, as mentioned above, the corresponding received gains can be individually set. The method can thus further comprise determining, for each transceiver, a sum of received signal strengths of transmit signals of other transceivers based on the adapted transmit signal strengths. The method can further comprise setting a received gain of the transceivers based on the respective sum of received signal strengths. A scenario can thus be replicated in which a plurality of transceivers can transmit simultaneously, e.g. using an OFDMA method. The dynamic range of the transceivers can simultaneously be utilized to optimum effect in receive mode.

It can be provided accordingly that the plurality of transceivers communicate with one another over a plurality of frequency bands so that, according to the number of frequency bands that are used, a corresponding number of transceivers can transmit simultaneously. The sum of received signal strengths can thus be formed based on the number of frequency bands that are used. The “loudest” other transceivers, for example, can be taken into account, according to the number of frequency bands that are used.

A third subject-matter is a program having a program code to carry out the method presented above when the program code is executed on a computer, a processor, a control module or a programmable hardware component.

The above-described features and advantages, as well as others, will become more readily apparent to those of ordinary skill in the art by reference to the following detailed description and accompanying drawings.

### BRIEF DESCRIPTION OF THE DRAWINGS

Some examples of devices and/or methods will be explained in detail below with reference to the attached figures, in which:

FIG. 1a shows a schematic diagram of a wired communication system;

FIG. 1b shows a schematic diagram of a use of a plurality of frequency bands for communication;

FIGS. 2a and 2b show diagrams of a loss of signals on a wired communication bus over different distances, with and without intermediate communication nodes;

FIGS. 3a to 3c show schematic diagrams of a dependence of received signal strengths in a wired communication system on a position of the respective transmitting transceiver;

FIG. 4a shows a tabular listing of the dependence of the received signal strengths in a wired communication system on the position of the respective transmitting transceiver;

FIG. 4b shows another tabular listing of the dependence of the received signal strengths in a wired communication system on the position of the respective transmitting transceiver;

FIG. 5 shows a block diagram of a method for determining a transmit signal strength of a plurality of transceivers which are interconnected via a wired communication bus; and

FIG. 6 shows a tabular listing of an effect of a use of individually adjusted transmit signal strengths by the transceivers of the wired communication system.

### DETAILED DESCRIPTION

Some examples will now be explained in more detail with reference to the attached figures. However, further possible examples are not restricted to the features of these embodiments described in detail. They can have modifications of the features and equivalents and alternatives to the features. The terminology used herein to describe specific examples is furthermore not intended to be restrictive for further possible examples.

In the entire description of the figures, identical or similar reference signs relate to the same or identical elements or features which can be implemented in each case identically or in a modified form, whilst providing an identical or similar function. The thicknesses of lines, layers and/or areas can be exaggerated in the figures for clarification purposes.

If two elements A and B are combined using the term “or”, this is to be understood to mean that all possible combinations are disclosed, i.e. A only, B only, and also A and B, unless expressly defined otherwise in individual cases. The phrase “at least one of A and B” or “A and/or B” can be used as an alternative wording for the same combinations. The same applies to combinations of more than two elements.

If a singular form, e.g. “a, one” and “the” is used and the use of only a single element is neither explicitly nor implicitly defined as mandatory, further examples can also use a plurality of elements in order to implement the same function. If a function is described below as being implemented using a plurality of elements, further examples can implement the same function using a single element or a single processing entity. Furthermore, the terms “comprises”, “comprising”, “has”, and/or “having”, when used to describe the presence of the indicated features, integers, steps, operations, processes, elements, components and/or a group thereof, obviously do not, however, exclude the presence or the addition of one or more other features, integers, steps, operations, processes, elements, components/and/or a group thereof.

The present disclosure focuses on improving or optimizing the transmit power in a communication, in particular in relation to OFDMA communication also. The present disclosure is based, in particular, on investigations into a vehicle communication bus with OFDMA. The following description sets out how an adaptation and, in particular, an improvement or optimization of the transmit power of the individual bus nodes can be undertaken depending on the respective bus topology, i.e. line length and number of participating nodes. This is done in the present concept through adaptation, e.g. reduction, of the transmit power, in particular of the inner nodes.

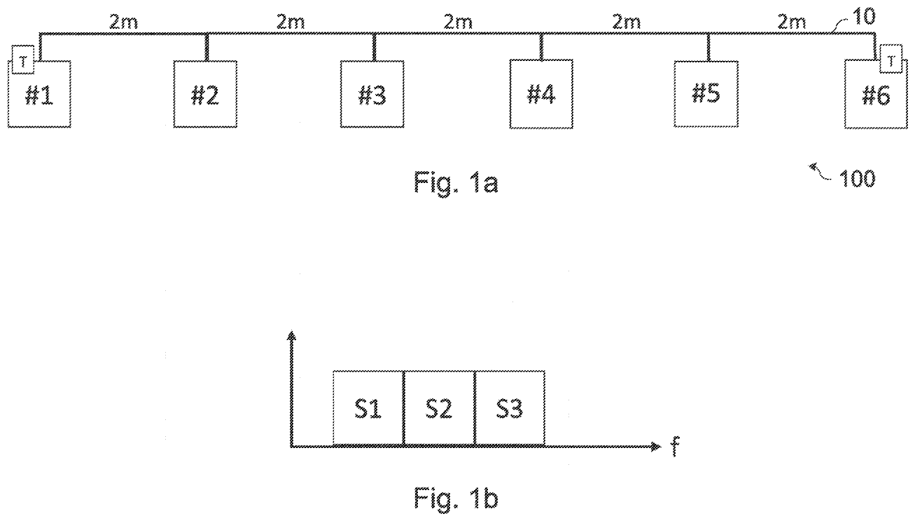

FIG. 1a shows a schematic diagram of a wired communication system 100. The wired communication system comprises a plurality of transceivers (#1-#6, also referred to below as nodes or communication nodes) which are interconnected via a wired communication bus 10. The wired communication bus can, for example, be a wired vehicle communication bus. A vehicle can accordingly comprise the communication bus 10 and the transceivers #1-#6. As shown in FIG. 1a, the wired communication bus can be terminated at both ends with terminators T. In other words, the wired communication bus system can be designed as a passive daisy chain. The communication bus can be implemented, for example, by means of coaxial cables or twisted pairs (TP, e.g. unshielded twisted pairs, UTP). Different communication protocols can be used to communicate via the wired communication bus. The transceivers can be designed accordingly to communicate via the wired communication bus on the basis of a communication protocol. FIG. 1a shows an example with six transceivers (also referred to as communication nodes), in each case having a 2 m line between the communication nodes and terminations T on the terminal nodes. However, the communication system is not restricted to such a design and can comprise any number of communication nodes and different line lengths.

In particular, a frequency division multiplex method, and, in particular, an orthogonal frequency division multiplex method, can be used for this purpose. FIG. 1b shows a schematic diagram of a use of a plurality of frequency bands for communication. As shown in FIG. 1b, the plurality of transceivers can be designed to communicate with one another over a plurality of frequency bands S1; S2; S3 so that, according to the number of frequency bands that are used, a corresponding number of transceivers can transmit simultaneously. The example shown in FIG. 1b illustrates the use of the communication bands S1, S2 and S3, which can be chosen as orthogonal to one another. OFDM (Orthogonal Frequency Division Multiplexing), for example, such as OFDMA, can be used in order to communicate via the wired communication bus (e.g. OFDMA via a physical bus line), e.g. in accordance with the Institute of Electrical and Electronics Engineers (IEEE) communication standard 1901 or the ITU (International Telecommunication Union) standard G.hn. In OFDMA, a broadband signal is divided into a multiplicity of subcarriers (i.e. different frequency ranges). The subcarriers are grouped into subbands. This produces a plurality of communication channels which enable simultaneous communication. Different nodes can transmit simultaneously here. In the example shown in FIG. 1b, three transceivers, for example, can transmit simultaneously on the three subbands S1, S2 and S3 without necessarily resulting in collisions.

Transceivers are mentioned in the present disclosure. This term generally refers to communication components which can both transmit and receive. The transceivers #1-#6 can accordingly contain typical transmitter or receiver components. This can include, for example, one or more antennas, one or more filters, one or more mixers, one or more amplifiers, one or more diplexers, one or more duplexers, etc. However, in some embodiments of the wired communication one or system, more of the transceivers can act exclusively as a receiver. In this case, the term transceiver also encompasses pure receivers. In other words, one or more of the transceivers can be pure receivers, i.e. have no transmit components, or a transmit functionality of the corresponding transceivers can be deactivated, unused or only occasionally used, e.g. during initialization.

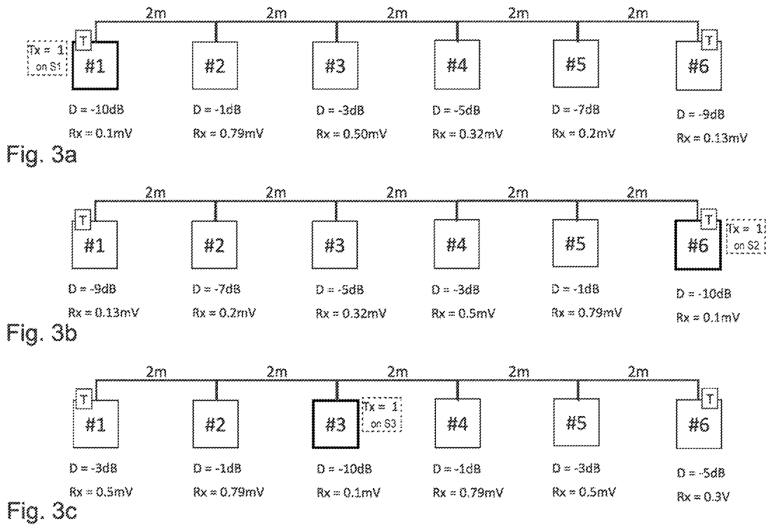

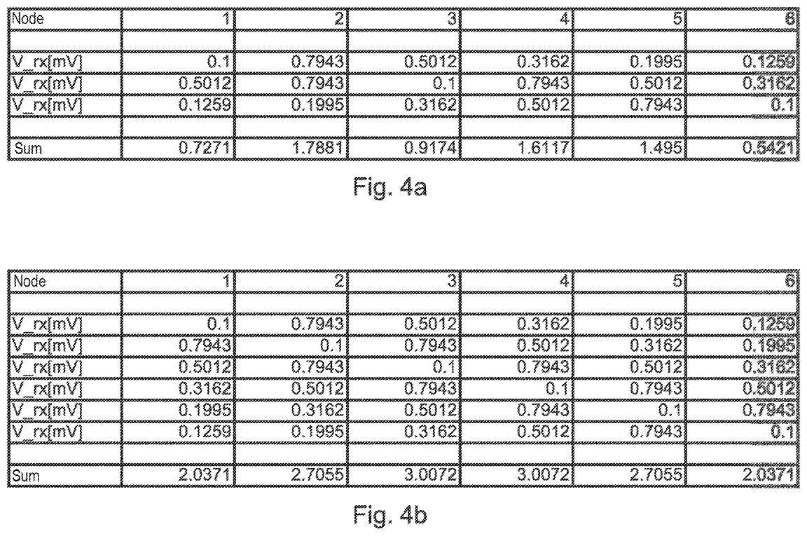

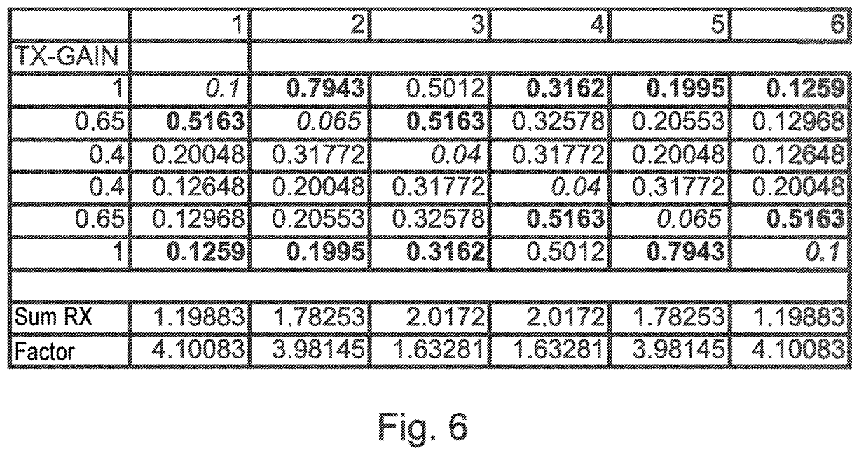

The initial situation is outlined briefly in the following diagrams. This is done to provide an understanding of the numbers on which FIGS. 3a to 3c, 4a and 4b, and also FIG. 6 are based. However, the aspects of the present disclosure is not restricted to these numbers. Cable lengths, insertion losses, the number of transceivers, the number of subbands, etc., can therefore differ.

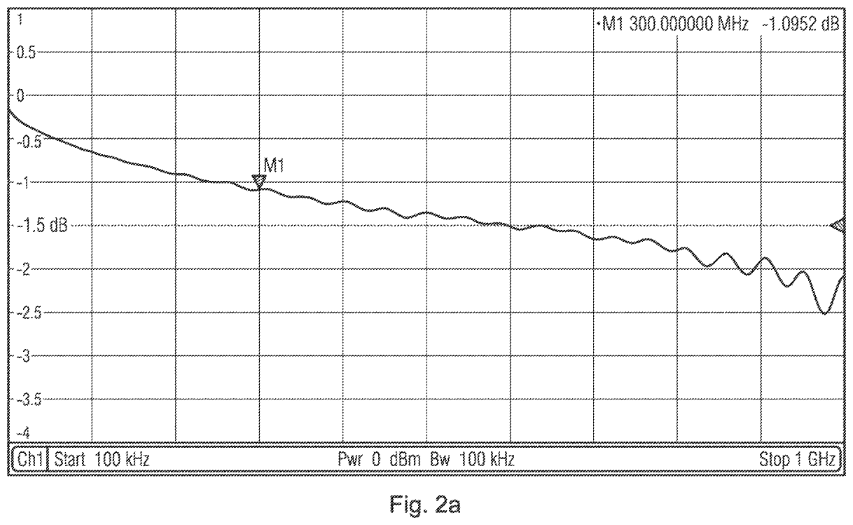

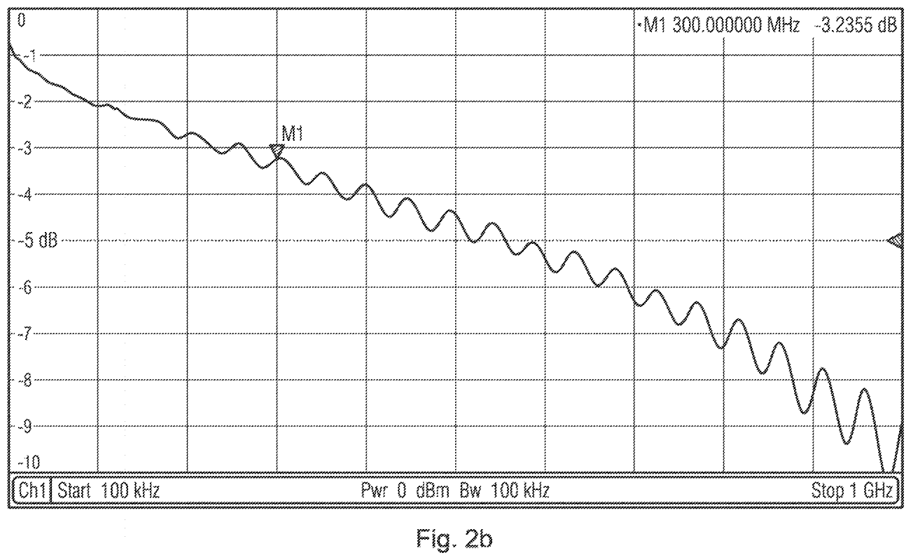

FIGS. 2a and 2b show diagrams of a loss of signals on a wired communication bus over different distances with and without intermediate communication nodes. As shown in FIGS. 2a and 2b, the cables on which the numbers are based have an insertion loss which decreases strictly monotonically from 1 MHz to, for example, 300 MHz. A loss of 0.5 dB/m at a carrier frequency of 300 MHz is assumed in the example. The communication nodes have an insertion loss which decreases strictly monotonically from 1 MHz to 300 MHz. A loss of 1 dB at 300 MHz is assumed in the example. FIG. 2a shows the loss over a cable 2 m in length. FIG. 2b shows the loss over a 4 m cable, with additional loss due to an intermediate communication node.

FIGS. 3a to 3c show an example consideration in which the transmit signal strengths of the individual nodes are set as equal. The signal voltage (transmit signal voltage) is normalized to 1 mV, the near-end crosstalk (NEXT) is −10 dB (in an example application with a hybrid circuit). FIGS. 3a to 3c show, in particular, schematic diagrams of a dependence of received signal strengths in a wired communication bus on a position of the respective transmitting transceiver.

In FIG. 3a, node #1 transmits (i.e. TX=1 from subband 1, where TX stands for transmit). The loss at node #1 is assumed to be −10 dB (due to NEXT), so that, from a transmit signal having a transmit signal strength (transmit signal voltage) of 1 mV, a received signal strength (received voltage) of 0.1 mV is received by node which is distanced by one cable #1. At node #2, connection from node #1, a loss of −1 dB and a received signal strength of 0.79 mV occur. At node #3, which is distanced from node #1 by two cable connections and one intermediate node, a loss of −3 dB and a received signal strength of 0.5 mV occur. At node #4, which is distanced from node #1 by three cable connections and two intermediate nodes, a loss of −5 dB and a received signal strength of 0.32 mV occur. At node #5, which is distanced from node #1 by four cable connections and three intermediate nodes, a loss of −7 dB and a received signal strength of 0.2 mV occur. At node #6, which is distanced from node #1 by five cable connections and four intermediate nodes, a loss of −9 dB and a received signal strength of 0.13 mV occur.

Corresponding values occur if node 6 transmits (i.e. TX=1, on subband 2), as shown in FIG. 3b. Here, the values are mirrored compared to the example shown in FIG. 3a, so that node #5 is distanced from node #6 by one cable connection, and a loss of −1 dB and a signal strength of 0.79 mV occur, etc.

In FIG. 3c, node #3 transmits on subband 3 (TX=1 for S3). Here, nodes #2 and #4 are in each case distanced from node #3 by one cable connection, so that a loss of −1 dB and a signal strength of 0.79 mV occur on these nodes, etc.

FIGS. 4a and 4b show a tabular listing of the dependence of the received signal strengths in a wired communication system on the position of the respective transmitting transceiver. FIG. 4a shows the numbers for the examples from FIGS. 3a to 3c. The first contents row (third row of FIG. 4a) shows the occurring received signal strengths when node #1 transmits, the second contents row shows the occurring received signal strengths when node #3 transmits, and the third contents row shows the occurring received signal strengths when node #6 transmits. The numbers for all transceivers are shown in FIG. 4b. The first contents row (third row of FIG. 4b) shows the occurring received signal strengths when node #1 transmits, the second contents row shows the occurring received signal strengths when node #2 transmits, etc. The sum of the received signal strengths on the respective nodes is further shown in the last row of FIG. 4b. It is evident here that the sum is higher on the inner nodes than on the outer nodes, since the average distance to other nodes is less in the case of the inner nodes.

Based on this example of an initial situation, the following description explains how the transmit power of the individual transmitters can or should be set. In particular, two criteria are defined which can be taken into account in order to set the transmit power. On one hand, the transmit signal strength (e.g. the transmit signal voltage or transmit power) of the transmitters can be set such that the received signal strength (i.e., for example, the received signal voltage) of the transmit signals emitted by the different transmitters is as similar as possible (i.e. as equally high as possible). Consequently, the received gain of the transceivers can be set on the basis of the sum of the received signal strengths (e.g. received signal voltages) in order to ensure that the sum of the received signal strengths controls the full dynamic range of the analog-to-digital converter (AD converter) of the respective transceiver.

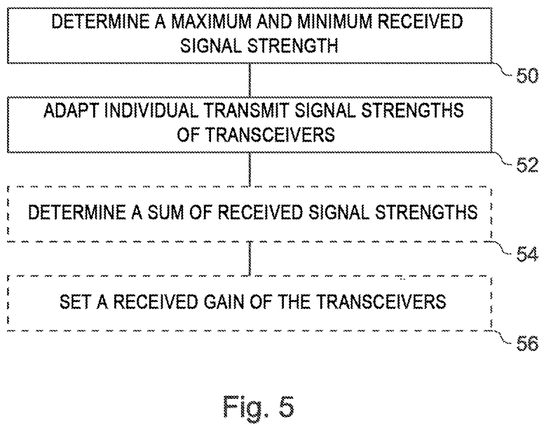

FIG. 5 thus shows a corresponding (computer-implemented) method for determining (and/or setting) a transmit signal strength of the plurality of transceivers. FIG. 5 shows a block diagram of a method for determining and/or setting a transmit signal strength of a plurality of transceivers which are interconnected via a wired communication bus. The transmit signal strengths, for example, and/or a respective received gain of the transceivers #1-#6 of the communication system 100 from FIG. 1a can be set by means of the method shown in FIG. 5.

The method comprises determining 50 (e.g. calculating), for each transceiver, a maximum received signal strength and a minimum received signal strength of transmit signals of other transceivers based on a predefined transmit signal configuration. The method strength further comprises adapting 52 (e.g. determining and setting) the individual transmit signal strengths of the transceivers such that a ratio between the maximum received signal strength and the minimum received signal strength of transmit signals of other transceivers is reduced compared to other transmit signal strength configurations.

Consequently, a transmit signal strength of the respective transceivers #1-#6 in FIG. 1a can be individually set such that, on the respective transceivers, the ratio between the maximum received signal strength and the minimum received signal strength of transmit signals of the other transceivers is reduced compared to other transmit signal strength configurations. In particular, the transmit signal strength of the respective transceivers can be individually set such that, on the respective transceivers, the ratio between the maximum received signal strength and the minimum received signal strength of transmit signals of other transceivers is reduced, in particular compared to a transmit signal strength configuration in which each transceiver uses the same transmit signal strength.

This can be done by varying the transmit signal strengths (e.g. transmit signal voltages) of the transceivers in a mathematical model of the communication system, and by selecting a transmit signal strength configuration in which the ratio between the maximum received signal strength and the minimum received signal strength of the other transmit signals of transceivers is reduced compared to other transmit signal strength configurations, and, in particular, compared to a transmit signal strength configuration in which each transceiver uses the same transmit signal strength. The mathematical model can replicate, for example, parameters such as line loss of the communication system, insertion loss of the transceivers, etc. The respective transmit signal strengths can then be modified as variable parameters in the mathematical model during the adaptation 52 of the individual transmit signal strengths in order to calculate the corresponding ratios on the basis thereof. The desired transmit signal strength configuration can be characterized in that the transmit signals of the individual transceivers differ from one another. The plurality of transceivers can thus comprise at least a first transceiver and a second transceiver, wherein a transmit signal strength of the first transceiver differs from a transmit signal strength of the second transceiver. As a starting point, the transmit signal strength of the outer transceivers (i.e. the transceivers which are arranged further toward the edge of the communication bus) can be chosen as higher than the transmit signal strength of the inner transceivers (i.e. the transceivers which are arranged further toward the middle of the communication bus). The transmit signal strengths can be adapted iteratively until no further improvements in the respective ratios are identified. A “greedy” method, for example, can be applied, in which the transmit signal strengths are adapted iteratively in a direction in which, initial transmit signal strength starting from an configuration, the ratios are reduced. An optimization, for example, of the transmit signal strengths in relation to the sum or the average of the ratios can be performed. Here, optimization does not mean that the optimum transmit signal strength configuration is necessarily determined, but only that a transmit signal strength configuration is determined which is improved compared to an original transmit signal strength configuration.

In some communication systems, it can be provided that some transceivers never transmit or transmit only seldomly (e.g. only during initialization). Such transceivers can, for example, be ignored or can be taken into account to a lesser extent in determining the respective transmit signal strengths. Thus, (only) transmit signals from transceivers (e.g. nodes #1; #3; #6 in FIGS. 3a to 4a) for which it is provided that they (regularly) communicate via the communication bus in transmit mode can be taken into account.

FIG. 6 shows a tabular listing of an effect of a use of individually adjusted strengths by the transceivers of the wired communication system. As described above, the signal voltage of the received signals of the individual transmitters on a receive node can be as equally high as possible. This can be achieved through the introduction of gain factors TX-gain (transmit gain) for the transmitters, as shown in the first column. Different transmit gain factors have been determined here, as shown in the first column. A transmit gain factor of 1 has been determined for the outer transceivers #1 and #6 (first and sixth row with useful values), a transmit gain factor of 0.65 has been determined for the transceivers #2 and #5, and a transmit gain factor of 0.4 has been determined for the inner transceivers #3 and #4. This results in a ratio (referred to as a “factor” in FIG. 6) of 4.1 for the outer transceivers #1 and #6, of 3.98 for the transceivers #2 and #5, and in a ratio of 1.63 for the transceivers #3 and #4. The ratio shown in the last row (Sum RX) is calculated from the maximum and the minimum of the column (which are shown in bold), excluding the NEXT values, and should be reduced or should assume a minimum.

The receiver gains can now be set based on the determined transmit signal strengths. This can be obtained, for example, from the sum of the received signal strengths of the received signals potentially arriving simultaneously at a transceiver, as shown in the penultimate row of FIG. 6 for the example from FIGS. 3a to 4b. The sum of the received signal strengths (received signal voltages) is intended to control the full dynamic range of the AD converter of the receiver. This can be done by setting an analog gain circuit of the respective receiver. The method from FIG. 5 can thus further comprise determining 54, for each transceiver, a sum of received signal strengths of transmit signals of other transceivers based on the adapted transmit signal strengths, and setting 56 a received gain (e.g. a gain factor of an analog gain circuit of the receive component) of the transceivers based on the respective sum of received signal strengths. A received gain of the transceivers can thus be set on the respective transceiver based on a sum of received signal strengths.

As described in the introduction to FIG. 1b, the proposed concept is usable, in particular, in conjunction with frequency division multiplex methods. The maximum simultaneous received signal strength to be expected (which can be composed of a plurality of received signals) is derived from the number of frequency bands that are used, e.g. the subbands S1, S2 and S3. Thus, in the example shown in FIGS. 3a to 3c, the nodes #1, #3 and #6, for example, can transmit simultaneously, as a result of which the sum of the received signal strengths is obtained from the received signal strengths of the received signals of these transceivers. Thus, in the example shown in FIGS. 3a to 4a, the three weakest received signals can still be ignored, since there are only three transmitters (subbands). The sum of received signal strengths can be formed accordingly based on the number of simultaneously used frequency bands. If, for example, n frequency bands are used, the n greatest received signal strengths can be added together. Further restrictions can be applied if each transceiver communicates in transmit mode in only one of the frequency bands. Thus, for example, the highest received signal strength can be selected for each frequency band, and the sum can be formed by means of the respective highest received signal strength. A procedure of this type is applicable, for example, if filters are used for the individual frequency bands. Although these are not provided in pure OFDMA, they can be added, as a result of which a UFMC (Universal Filtered MultiCarrier) communication can be performed by means of the communication system.

The present concept has been described in relation to vehicle communication buses, but can also be adapted to other (wired or wireless) communication buses, e.g. in automation technology.

The aspects and features described in connection with one specific example of the previous examples can also be combined with one or more of the further examples in order to replace an identical or similar feature of this further example, or in order to introduce the feature additionally into the further example.

Examples can further be or relate to a (computer) program having a program code to carry out one or more of the above methods when the program is executed on a computer, a processor or other programmable hardware component. Steps, operations or processes of various examples of the methods described above can therefore also be executed by programmed computers, processors or other programmable hardware components. Examples can also cover program storage devices, e.g. digital data storage media which are machine-readable, processor-readable or computer-readable and which encode or contain machine-executable, processor-executable or computer-executable programs and instructions. The program storage devices can comprise or be e.g. digital storage devices, magnetic storage media such as, for example, magnetic discs and magnetic tapes, hard disk drives or optically readable digital data storage media. Further examples can also cover computers, processors, control units, field-programmable logic arrays ((F) PLAs), field-programmable gate arrays ((F) PGAs), graphics processor units (GPUs), application-specific integrated circuits (ASICs), integrated circuits (ICs) or systems-on-chip (SoCs), which are programmed to carry out the steps of the methods described above.

It is further obvious that the disclosure of a plurality of steps, processes, operations or functions disclosed in the description or the claims is not necessarily intended to be interpreted as stipulating the performance thereof in the sequence described, unless this is explicitly indicated or is a mandatory requirement in individual cases on technical grounds. The performance of a plurality of steps or functions is therefore not limited by the preceding description to a specific sequence. Moreover, in further examples, an individual step, an individual function, an individual process or an individual operation can include and/or can be broken down into substeps, subfunctions, subprocesses or suboperations.

If some aspects have been described in the preceding sections in connection with a device or a system, these aspects are also to be understood as a description of the corresponding method. A block, a device or a functional aspect of the device or of the system, for example, can correspond to a feature, e.g. a method step, of the corresponding method. Correspondingly, aspects which are described in connection with a method are also to be understood as a description of a corresponding block, a corresponding element, a characteristic or a functional feature of a corresponding device or of a corresponding system.

The following claims are hereby incorporated into the detailed description, wherein each claim can stand as a separate example on its own. It should further be noted that—although a dependent claim refers in the claims to a specific combination with one or more other claims—other examples can also comprise a combination of the dependent claim with the subject-matter of any other dependent or independent claim. Such combinations are hereby explicitly proposed, unless it is otherwise indicated in individual cases that a specific combination is not intended. Features of one claim are furthermore also intended to be included in every other independent claim, even if this claim is not directly defined as dependent on this other independent claim.

### REFERENCE SIGNS

#1-#6 Node, transceiver
10 Communication bus
50 Determine a maximum and minimum received signal strength
52 Adapt individual transmit signal strengths of transceivers
54 Determine a sum of received signal strengths
56 Set a received gain of the transceivers
100 Communication system
S1, S2, S3 Subbands

1-12. (canceled)

13. A wired communication system, comprising:
a plurality of transceivers which are interconnected via a wired communication bus; and
wherein a transmit signal strength of the respective transceivers is individually set such that, on the respective transceivers, a ratio between a maximum received signal strength and a minimum received signal strength of transmit signals of other transceivers is reduced compared to other transmit signal strength configurations of the respective transceivers.

14. The wired communication system as claimed in claim 13, wherein the other transmit signal strength configurations includes a configuration in which the transmit signal strengths of the respective transceivers are the same.

15. The wired communication system as claimed in claim 14, wherein a received gain of the transceivers is set based on a sum of received signal strengths on the respective transceiver.

16. The wired communication system as claimed in claim 15, wherein the plurality of transceivers are designed to communicate with one another over a plurality of frequency bands so that, according to the number of frequency bands that are used, a corresponding number of transceivers can transmit simultaneously, wherein the sum of received signal strengths is formed based on the number of frequency bands that are used.

17. The wired communication system as claimed in claim 16, wherein the plurality of transceivers are supported by a vehicle.

18. The wired communication system as claimed in claim 15, wherein transmit signals of transceivers, said transceivers communicate in transmit mode via the communication bus are taken into account in determining the received signal strengths.

19. The wired communication system as claimed in claim 13, wherein the transmit signal strength at least some of the respective transceivers is individually changed such that, on the respective transceivers, the ratio between the maximum received signal strength and the minimum received signal strength of transmit signals of other transceivers is reduced compared to other transmit signal strength configurations.

20. The wired communication system as claimed in claim 13, wherein the plurality of transceivers are designed to communicate with one another over a plurality of frequency bands so that, according to the number of frequency bands that are used, a corresponding number of transceivers can transmit simultaneously.

21. The wired communication system as claimed in claim 13, wherein a received gain of the transceivers is set based on a sum of received signal strengths on the respective transceiver.

22. The wired communication system as claimed in claim 21, wherein the plurality of transceivers are designed to communicate with one another over a plurality of frequency bands so that, according to the number of frequency bands that are used, a corresponding number of transceivers can transmit simultaneously, wherein the sum of received signal strengths is formed based on the number of frequency bands that are used.

23. The wired communication system as claimed in claim 13, wherein the plurality of transceivers comprises at least a first transceiver and a second transceiver, wherein a transmit signal strength of the first transceiver differs from a transmit signal strength of the second transceiver.

24. The wired communication system as claimed in claim 13, wherein transmit signals of transceivers, said transceivers communicate in transmit mode via the communication bus are taken into account in determining the received signal strengths.

25. The wired communication system as claimed in claim 13, wherein the transmit signal strengths are set by:
determining, for each transceiver, a maximum received signal strength and a minimum received signal strength of transmit signals of other transceivers based on a predefined transmit signal strength configuration; and
adapting at least a set of the individual transmit signal strengths of the transceivers such that the ratio between the maximum received signal strength and the minimum received signal strength of transmit signals of other transceivers is reduced compared to other transmit signal strength configurations of the transceivers.

26. The wired communication system as claimed in claim 13, wherein the received gain of the transceivers is set by:
determining, for each transceiver, a maximum received signal strength and a minimum received signal strength of transmit signals of other transceivers based on a predefined transmit signal strength configuration; and
adapting the received gain of the transceivers such that the ratio between the maximum received signal strength and the minimum received signal strength of transmit signals of other transceivers is reduced compared to other transmit signal strength configurations of the transceivers.

27. A method for determining a transmit signal strength of a plurality of transceivers which are interconnected via a wired communication bus, the method comprising:
determining, for each transceiver, a maximum received signal strength and a minimum received signal strength of transmit signals of other transceivers based on a predefined transmit signal strength configuration; and
adapting at least a set of the individual transmit signal strengths of the transceivers such that a ratio between the maximum received signal strength and the minimum received signal strength of transmit signals of other transceivers is reduced compared to other transmit signal strength configurations of the transceivers.

28. The method as claimed in claim 27, further comprising determining, for each transceiver, a sum of received signal strengths of transmit signals of other transceivers based on the adapted transmit signal strengths, and setting a received gain of at least one of the transceivers based on the respective sum of received signal strengths.

29. The method as claimed in claim 27, wherein the plurality of transceivers communicate via the wired communication bus over a plurality of frequency bands so that, according to the number of frequency bands that are used, a corresponding number of transceivers can transmit simultaneously, and wherein the sum of received signal strengths is formed based on the number of frequency bands that are used.

30. A non-transitory storage medium storing program code to carry out the method as claimed claim 27 when the program code is executed on a computer, a processor, a control module or a programmable hardware component.
